(19) United States
(12) Patent Application Publication
(10) Pub. No.: US 2004/0265774 A1
(43) Pub. Date: Dec. 30, 2004

(54) Non-traumatic saliva ejector tip

(76) Inventor: Joseph Cholewa, Montreal (CA)

Correspondence Address: Joseph Cholewa, Suite 817, 1414 DRUMMOND St., Montreal, QC, H3G, CA

(21) Appl. No.: 10/609,500

(22) Filed: Jun. 30, 2003

(51) Int. Cl. A61C 17/06

(52) U.S. Cl. 433/91

(57) ABSTRACT

What my invention brings that is new to the field of dentistry is the following: the saliva ejector tip which I have designed with holes in it rather than slots (as in existing tips) will not suck in snag or injure the delicate tissue of the floor of the mouth. Most of us have endured this unpleasant experience, as the saliva ejector is used during the majority of procedures in dentistry. As a dentist and as a patient this is a problem I would like to have eliminated in a simple and cost effective way. As a dentist, I believe a saliva ejector with such a tip will be universally accepted and widely used

### CROSS-REFERENCE TO SPECIFIC APPLICATIONS

n/a

### STATEMENT REGARDING FEDERALLY SPONSORED RESEARCH AND DEVELOPMENT

n/a

### REFERENCE TO SEQUENCE LISTING, A TABLE, OR A COMPUTER PROGRAM LISTING COMPACT DISK APPENDIX

n/a

### BACKGROUND OF THE INVENTION

The field of endeavour to which the invention pertains is the field of dentistry. Specific problems involved in the prior art would involve the entrapment and laceration of tissue of the floor of the mouth and specifically the anterior area overlying the salivary glands.

### BRIEF SUMMARY OF THE INVENTION

The existing design of saliva ejector tip very often will suck in the tissue overlying the salivary glands of the anterior portion of the floor of the mouth especially in middle-aged and older patients. This tissue will become entrapped as the tissue is injured and swells up inside the saliva ejector tip. Removal of the saliva ejector is difficult and laborious with patients sometimes showing signs of panic. Once removed, the tissue is invariably red and swollen and often there is bleeding. By perforating the tip with small holes rather than long slits as is presently done, the tissue cannot be sucked in.

### DETAILED DESCRIPTION OF THE INVENTION

There is at present a saliva ejector commonly in use whose tip is designed in such a way as to allow suction and injury to tissues of the floor of the mouth. This occurs because of slits cut in to the tip, which allow for saliva to be sucked in. The length of the slits, however, facilitates the aspiration of tissues of the anterior portion of the mouth where the saliva ejector is most commonly placed. This occurs almost regularly in older patients where the tissue becomes flaccid with age. An improvement to the design would be as follows: the tip of the saliva ejector should be perforated with holes of 1 mm diameter arrayed in the following pattern: 6 circumferentially on the end and 2 mm from the edge, and 2 rows of six holes each around the perimeter. The two rings lie 3 mm and 5 mm from the end of the ejector tip. This saliva ejector tip can be manufactured in the same manner as the existing slotted tip (except for the substitution of holes for the slots, as described) and can be fastened to the saliva ejector tube in the same manner as is presently done for the slotted head.

### DESCRIPTION OF SEVERAL VIEWS OF THE DRAWING

FIG. 1 shows a view seen from the top of the saliva ejector tip. Seen are six holes of one mm diameter each, placed circumferentially, 2 mm from the edge.

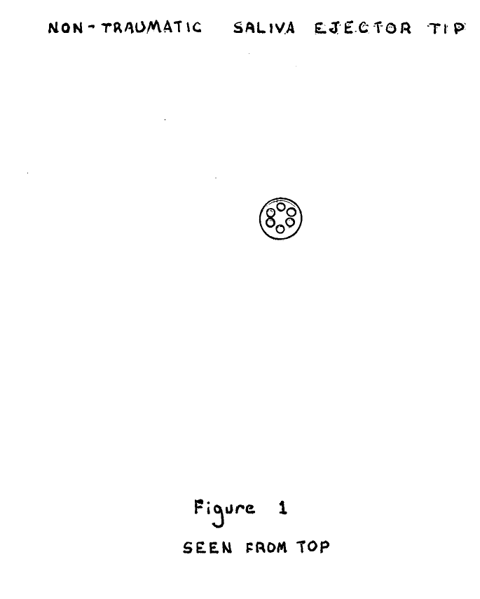

FIG. 2 shows a view seen from the side of the saliva ejector tip. Seen are four holes of one mm diameter each. The top two holes are two of six holes evenly spaced and placed circumferentially 3 mm from the end of the tip. The lower two holes are two of six holes, evenly spaced and placed circumferentially 5 mm from the end of the tip.

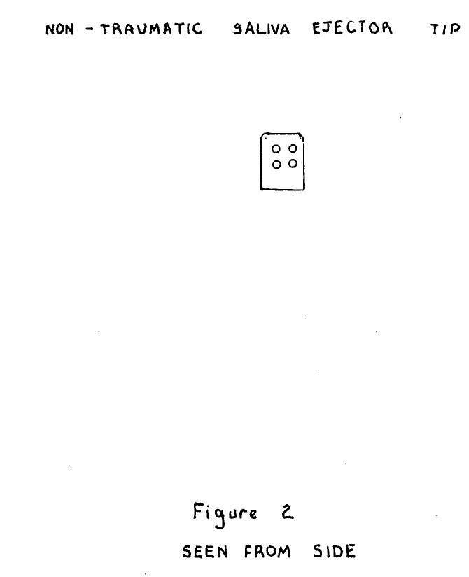

1. What I claim as my invention is a saliva ejector tip made of acrylic material, perforated with holes of 1 mm diameter and arranged as follows: 6 circumferentially on the end, evenly spaced, 2 mm from the edge, and 6 holes of 1 mm diameter arranged in two rows and evenly spaced around the perimeter. The rows are placed 3 mm and 5 mm from the end of the tip respectively.
